(19) United States
(12) Patent Application Publication
(10) Pub. No.: US 2004/0126230 A1
(43) Pub. Date: Jul. 1, 2004

(54) Diffuser for a centrifugal compressor

(75) Inventors: Leonardo Baldassarre, Florence (IT); Massimo Camatti, Serravalle Pistoiese (IT)

Correspondence Address: NIXON & VANDERHYE P.C./G.E., 1100 N. GLEBE RD., SUITE 800, ARLINGTON, VA, 22201, US

(73) Assignee: NUOVO PIGNONE HOLDING S.p.A., Florence (IT)

(21) Appl. No.: 10/735,871

(22) Filed: Dec. 16, 2003

(30) Foreign Application Priority Data
Dec. 17, 2002 (IT) MI2002A 002661

(51) Int. Cl. F03B 1/00

(52) U.S. Cl. 415/208.2

(57) ABSTRACT

An improved diffuser (10) for a centrifugal compressor which comprises blading with blades (12).

The present invention relates to an improved diffuser for a centrifugal compressor.

As is known, a centrifugal compressor is a machine which returns a compressible fluid at a pressure which is greater than that at which it received the fluid, by imparting to the fluid the energy necessary for the change of pressure, by means of use of one or a plurality of rotors or impellers.

Each rotor comprises a certain number of blades, which are disposed radially such as to form a certain number of passages which converge towards the centre of the rotor.

In high-pressure centrifugal compressors, the impellers rotate in stators which comprise an inner case, diffusers and diaphragms.

From the point of view of the performance of the centrifugal compressor, there are two main aspects to be taken into consideration, i.e. the polytropic output (in particular from the design point of view) and the operative field.

A phenomenon which is particularly important, especially in the field of high-pressure machines, is that of rotary stall of the diffuser.

As is known, when the flow rate produced by the machine is reduced, the gas tends to enter the diffuser with angles which are increasingly small (relative to the tangential direction). When a minimum value of this angle is reached, the diffuser reaches the condition of rotary stall.

This condition is characterised by the occurrence of pressure pulses at low frequency (the ratio between the pulse frequency and that of rotation is normally between 0.1 and 0.2). The intensity of the pulses is directly proportional to the density of the gas, and thus to the pressure of the gas inside the diffuser.

It can then clearly be understood that on high-pressure machines these pulses tend to become particularly strong, to the extent in fact that these oscillating forces lead to equally violent vibrations of the shaft, thus preventing use of the machine itself. The presence of this phenomenon thus gives rise to limitation of the use of the machine solely to a specific field of operative conditions (with low flow rates).

The solution used in order to mitigate this phenomenon, i.e. in other words to displace the rotary stall outside the contractual operative field, usually consists of reducing the opening for passage of the gas into the diffuser.

For the same flow rate produced by the machine, this therefore provides the effect of increasing the angle of the gas in the diffuser, and thus of averting the critical conditions of occurrence of the phenomenon.

However, the reduction of the opening for passage into the diffuser has important consequences on the efficiency of the stage concerned, and of the machine.

In fact, with the restrictions of the opening which are normally required, and are necessary in order to solve the problem, and can for example be 30% of the opening of the impeller, there is penalisation which can be as much as 5% of the output of the stage.

The object of the present invention is thus to eliminate the disadvantages previously described, and in particular to provide an improved diffuser for a centrifugal compressor, which makes it possible to displace the phenomenon of rotary stall outside the contractual operative field, whilst however maintaining a high level of performance of the stage, which is even better than that which can be obtained with a diffuser according to the known art, with an opening with a reduced passage.

Another object of the present invention is to provide an improved diffuser for a centrifugal compressor, which comprises an increase in the operative field of the machine.

Another object of the present invention is to provide an improved diffuser for a centrifugal compressor, which is particularly reliable, functional, and has relatively low costs.

These objects and others according to the invention are achieved by providing an improved diffuser for a centrifugal compressor, as described in claim 1.

Further characteristics of an improved diffuser for a centrifugal compressor are indicated in the successive claims.

The characteristics and advantages of an improved diffuser for a centrifugal compressor according to the present invention will become more apparent and evident from the following description, provided by way of non-limiting example, with reference to the attached schematic drawings, in which:

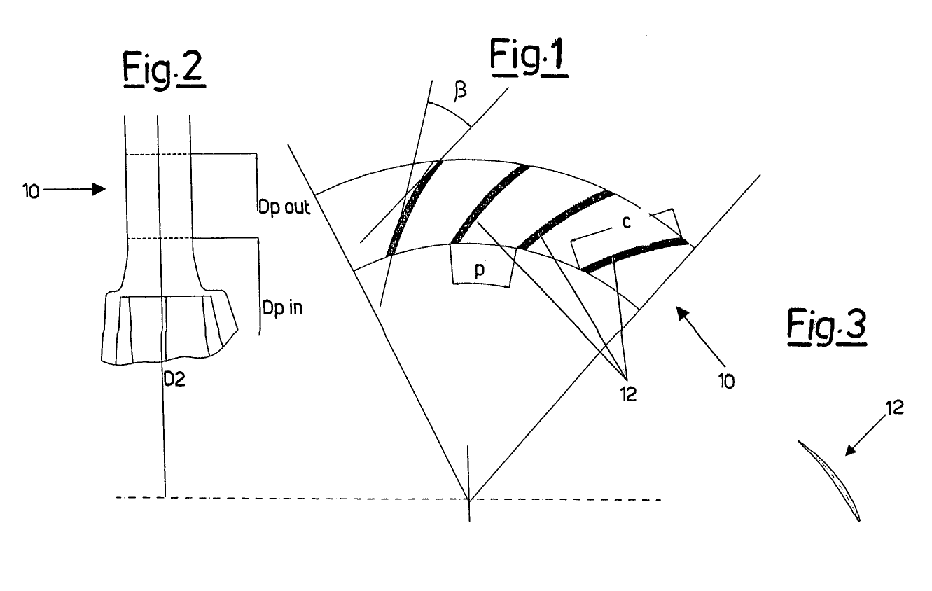

FIG. 1 is a diagram of a portion of an improved diffuser for a centrifugal compressor according to the present invention, showing blading wherein the median lines of the blades are drawn;

FIG. 2 shows an elevated lateral view of a portion of an impeller and diffuser assembly according to FIG. 1; and

FIG. 3 is an elevated front view of a blade of the blading in FIG. 1.

With initial reference to FIGS. 1 and 2, there is shown an improved diffuser, indicated as 10 as a whole, for a centrifugal compressor.

In the example illustrated, according to the present invention, the diffuser 10 comprises substantially blading with blades 12.

For the purposes of specifying an arrangement of the blades 12, the following variables, which are indicated in FIGS. 1 and 2, are introduced:

D2, i.e. the outer diameter of an impeller of the centrifugal compressor;

Dp in, i.e. the diameter of an intake edge of the blading;

Dp out, i.e. the diameter of an outlet edge of the blading;

β, i.e. the deflection of the blading, in other words the angle of displacement of a tangent line at the outlet of the blade 12, relative to a tangent line at the intake of the blade 12 itself;

p, i.e. the blading pitch of the diffuser, in other words

$$\frac{π \cdot Dp\_in}{Z} ,$$

wherein Z is the number of the blades 12; and

c, i.e. length of the blades 12, which is also known as the chord.

Other important variables are:

b2, i.e. outlet width of the impeller;

b3, i.e. width of the diffuser;

s, i.e. strength of the blade 12, provided by the ratio between p and c, in other words between the diffuser blading pitch and the chord of the blade 12.

The aforementioned variables are now indicated with numerical intervals for satisfactory operation, with particular reference to the positioning of the intake and outlet edge of the blades 12, the strength s of the blade 12, and the deflection β of the blading.

The positioning of the blades 12 is provided by one or both of the following ratios with reference to the outer diameter of the impeller D2:

(Dp in)/D2 between 1.04 and 1.14 with extreme values included;

(Dp out)/D2 between 1.25 and 1.35 with extreme values included.

The optimal deflection β of the blading is between an angle of 0° and an angle of 10°, including extreme values.

The strength s of the blade 12 has low values and an optimal configuration has been determined for values of between 0.5 and 1, including extreme values.

The preferred field of use is in centrifugal compressor stages with a coefficient of flow of 0.03 or less.

Advantageously, the design of the blades 12 can be optimised both by means of the so-called CFD, i.e. Computational Fluid Dynamic method (in other words a method for fluid-dynamics calculation), and by means of experimental methodology.

By means of the improved diffuser according to the invention, it is not necessary to implement any additional reduction of area of the diffuser.

Experimental tests show that it is possible to obtain substantial increases of performance (of up to five percentile points) compared with the known configuration of free vortex diffusers with a passage opening which is not reduced.

It is also found that there are substantial increases in the operative field of the centrifugal compressor; the rotary stall limit obtained coincides substantially with that of a free-vortex diffuser with a reduced opening (30% of the discharge opening of the impeller).

An application which is particularly suitable for the improved diffuser for a centrifugal compressor, according to the present invention, is that in a delivery diffuser of a centrifugal compressor for re-injection.

The description provided makes apparent the characteristics of the improved diffuser according to the present invention for a centrifugal compressor, and also makes apparent its advantages.

The following concluding points and comments are now made, such as to define the said advantages more clearly and accurately.

Firstly, it is found that the improved diffuser 10 makes it possible to displace the phenomenon of rotary stall outside the contractual operative field, whilst however maintaining a high level of performance of the stage, which in fact is better than that which can be obtained by means of a diffuser according to the known art, with a passage opening which is not reduced.

In addition, by means of the diffuser according to the invention, it is found that there is an increase in the operative field of the centrifugal compressor.

Furthermore, it is found that the improved diffuser of the invention, for a centrifugal compressor, is particularly reliable and has costs which are relatively low compared with the advantages obtained.

Finally, it is apparent that many modifications and variations, all of which come within the scope of the invention, can be made to the improved diffuser for a centrifugal compressor thus designed; in addition all the details can be replaced by technically equivalent elements. In practice, any materials, forms and dimensions can be used, according to technical requirements.

The scope of the invention is thus delimited by the attached claims.

1. Improved diffuser (10) for a centrifugal compressor, characterised in that it comprises blading with blades (12).

2. Improved diffuser (10) according to claim 1, characterised in that the said blading has a strength s of the said blades (12) which is between 0.5 and 1, including extreme values, the said strength s being provided by the ratio between the pitch p of the said blading and the chord c of the said blades (12), the said pitch p being provided by the ratio
$$\frac{π \cdot Dp\_in}{Z} ,$$
wherein Z is the number of the said blades (12) and Dp in is the diameter of an intake edge of the said blading.

3. Improved diffuser (10) according to claim 1 or claim 2, characterised in that a deflection β of the said blading, i.e. the angle of displacement of a tangent line at the outlet of the blade (12) relative to a tangent line at the intake of the blade (12), is between an angle of 0° and an angle of 10°, including extreme values.

4. Improved diffuser (10) according to claim 1 or claim 2 or claim 3, characterised in that the ratio between a diameter of an intake edge Dp in of the said blading and an outer diameter of an impeller D2 of the said centrifugal compressor, is between 1.04 and 1.14, including extreme values.

5. Improved diffuser (10) according to claim 1 or claim 2 or claim 3 or claim 4, characterised in that the ratio between a diameter of an outlet edge Dp out of the said blading and an outer diameter of an impeller D2 of the said centrifugal compressor, is between 1.25 and 1.35, including extreme values.

6. Improved diffuser (10) according to claim 1 or claim 2 or claim 3 or claim 4 or claim 5, characterised in that it is used in centrifugal compressor stages with a coefficient of flow of 0.03 or less.

7. Improved diffuser (10) according to claim 1, characterised in that a design of the said blades (12) is optimised by means of the so-called CFD i.e. Computational Fluid Dynamic method (in other words a method for fluid-dynamics calculation).

8. Improved diffuser (10) according to claim 1, characterised in that a design of the said blades (12) is optimised by means of experimental methodology.

9. Improved diffuser (10) according to claim 1, characterised in that it is used for delivery of a centrifugal compressor for re-injection.

10. Improved diffuser (10) for a centrifugal compressor, substantially as described and illustrated and for the purposes specified.
